(19) United States
(12) Patent Application Publication
(10) Pub. No.: US 2012/0282950 A1
(43) Pub. Date: Nov. 8, 2012

(54) Mobile Geolocation String Building System And Methods Thereof

(75) Inventors: Charles A. Meyer, Irving, TX (US); Jason A. Snyder, Hoboken, NJ (US); Kerry F. Gunther, Bethesda, MD (US); Patrick G. Peak, Bethesda, MD (US)

(73) Assignee: GOPOGO, LLC, Irving, TX (US)

(21) Appl. No.: 13/274,063

(22) Filed: Oct. 14, 2011

Related U.S. Application Data
(60) Provisional application No. 61/483,373, filed on May 6, 2011.

(51) Int. Cl. H04W 4/02

(52) U.S. Cl. 455/456.3

(57) ABSTRACT

A system for generating a string based upon a plurality of places and a relationship between two or more of those places. Of the plurality of places used in any given string, at least one of the places does not have associated taxonomy or other place related or entity related information (e.g., business hours, description of services, etc.). The strings represent an authentic user experience of a quality, character, and/or feel intended by the string author. The user experience can be further enhanced or guided through a narrative accompanying the string or places, written by the string author, that describes or invokes the quality, character or feel of the experience intended by the author.

### RELATED APPLICATION DATA

This application claims the benefit of priority of U.S. Provisional Patent Application Ser. No. 61/483,373, filed May 6, 2011, and titled “Geo-Location Based Playlist System and Method,” which is incorporated by reference herein in its entirety.

### FIELD OF THE INVENTION

The present invention generally relates to the field of web-based social interaction systems and methods. In particular, the present invention is directed to a computerized system and method of assembling a plurality of places and determining a relationship associated with the plurality of places using a mobile device so as to generate a string that is representative of an author's experience.

### BACKGROUND

The ability to share various pieces of information between individuals has increased dramatically in the digital age with the advent of various devices and computer programs that allow for near real-time knowledge about an individual's activities and whereabouts. While the information shared by authors may be distributed widely, the information is often fragmented and disjointed, robbing authors and receivers of the information of a more complete understanding of the experience the author is attempting to disseminate.

Various websites and applications adapted for mobile computing devices (“apps”) allow users to search and locate activities and places of interest. In some cases, an app used in conjunction with a mobile device having geolocation functionality may provide a display of activities (e.g., a movie) or places (e.g., a restaurant) of interest in relationship to the present location of the mobile device. Many known websites and apps search for, and locate, activities of interest when a static query is initiated by the user. Recommendations from this static query may be selected based on geographic proximity to the location of the mobile device.

For example, the Facebook® system allows users to periodically update a profile status, which may include a statement of current thoughts, an article the user is reading, a location the person is at, pictures the person has taken, and so forth. Facebook allows users to connect with other persons to create a social network, the other persons being able to view and comment on the profile status of the user. The user also receives the commentary of others in his or her network in time-sequence, thereby placing the most recent content of a person in the user's network as the first item to be reviewed by the user. The structure and organization of Facebook thereby allow for a review of a recent activity of a person by others, but fails to provide any connection between a multitude of activities of a user, which, when combined, disclose a more detailed and enriching experience.

### SUMMARY OF THE DISCLOSURE

One aspect of the present invention is a mobile geolocation relationship building system that comprises a mobile device coupled to a computer readable storage medium; a geolocation module configured to record in the computer readable storage medium an address for each of a plurality of places, wherein each of the plurality of places has a window associated therewith, and wherein at least one of the plurality of places does not include entity-related information; and a string module configured to develop a string including the plurality of places, wherein the plurality of places have a relationship that includes a first sequence of the windows associated with the plurality of places.

Another aspect of the present invention is a geolocation relationship building system comprising a mobile device and a machine readable storage medium including: an input module responsive to a designation of a place; and a string module configured generate a string including a plurality of the places, wherein at least one of the plurality of places does not include any entity related information, and wherein each of the plurality of places is assigned to a taxonomy category.

Yet another aspect of the present invention is a method of building relationships between at least two places designed by a user, the method comprising designating a first place with a mobile device using a user interface element on the mobile device, the designating occurring when the mobile device is located at the first place; designating a second place with the mobile device using the user interface element on the mobile device, wherein the second place does not include any entity related information and the designating occurs when the mobile device is located at the second place; producing a relationship between the first place and the second place based on a timeframe; and generating a string including the first place, the second place, and the relationship.

A further aspect of the present invention is a method of generating a string comprising receiving, from a mobile device having a user interface element, first place information, wherein the first place information represents a location of the mobile device, and wherein receipt of the first place information is initiated through the user interface element; receiving, from the mobile device, second place information, wherein the second place information represents a location of the mobile device, wherein the second place does not include entity related information, and wherein receipt of the second place information is initiated through the user interface element; producing a relationship associated with the first place and the second place based on the first place information, the second place information, and a timeframe; and generating a string including the first place, the second place, and the associated relationship.

Yet another further aspect of the present invention is a geolocation relationship building system for generating a string including a plurality of places, wherein at least one of the plurality of places does not include entity-related information, the system comprising a non-transitory computer-readable storage medium having executable computer program instructions for facilitating electronic analysis of the plurality of places, the computer program instructions including: a geolocation module configured to record in the non-transitory computer readable storage medium an address for each of the plurality of places; and a string module configured to develop a string having a relationship based upon the plurality of places, wherein the relationship includes a timeframe and a sequence of windows associated with the plurality of places.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 is a schematic representation of a mobile geolocation string building system (GSBS) according to an embodiment of the present invention;

FIG. 1A is a schematic representation of a mobile device including components of a mobile GSBS according to an embodiment of the present invention;

FIG. 2 is a block diagram of a taxonomy system according to an embodiment of the present invention;

FIG. 3 is a block diagram of a hierarchical organizational structure for strings according to an embodiment of the present invention; and

FIG. 4 is a histogram of string frequency according to an embodiment of the present invention;

FIG. 5 is a flow diagram of a method of creating a string using a mobile device according to an embodiment of the present invention;

FIG. 6 is a schematic representation of a mobile device suitable for use with a GSBS according to an embodiment of the present invention; and

FIG. 7 is a schematic representation of a mobile system suitable for use with a GSBS according to an embodiment of the present invention.

### DETAILED DESCRIPTION

A mobile geolocation string building system (GSBS) of the present invention generates a string based upon two or more places designed by a user, where at least one of the places does not have associated taxonomy, place, or entity related information (e.g., business hours, description of services, etc.). The string also includes a relationship, where the relationship is generated so as to establish a connection between the two or more places that, when performed, create or allow for the re-creation of an authentic user experience. The user experience can be further enhanced or guided through a narrative accompanying the string or places, written by the string author, that describes or invokes the quality, character, or feel of the experience intended by the author.

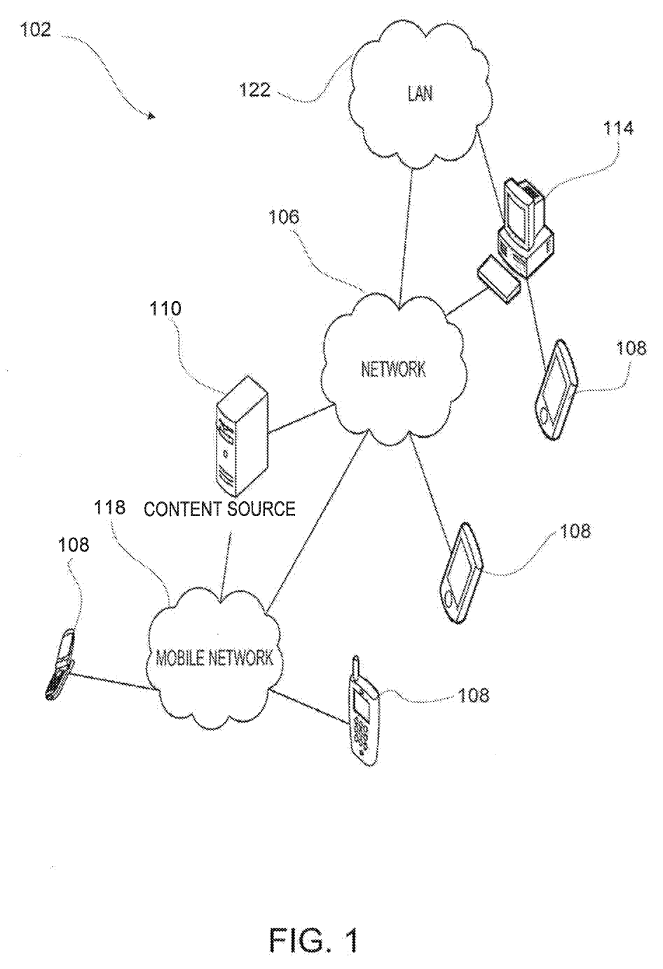

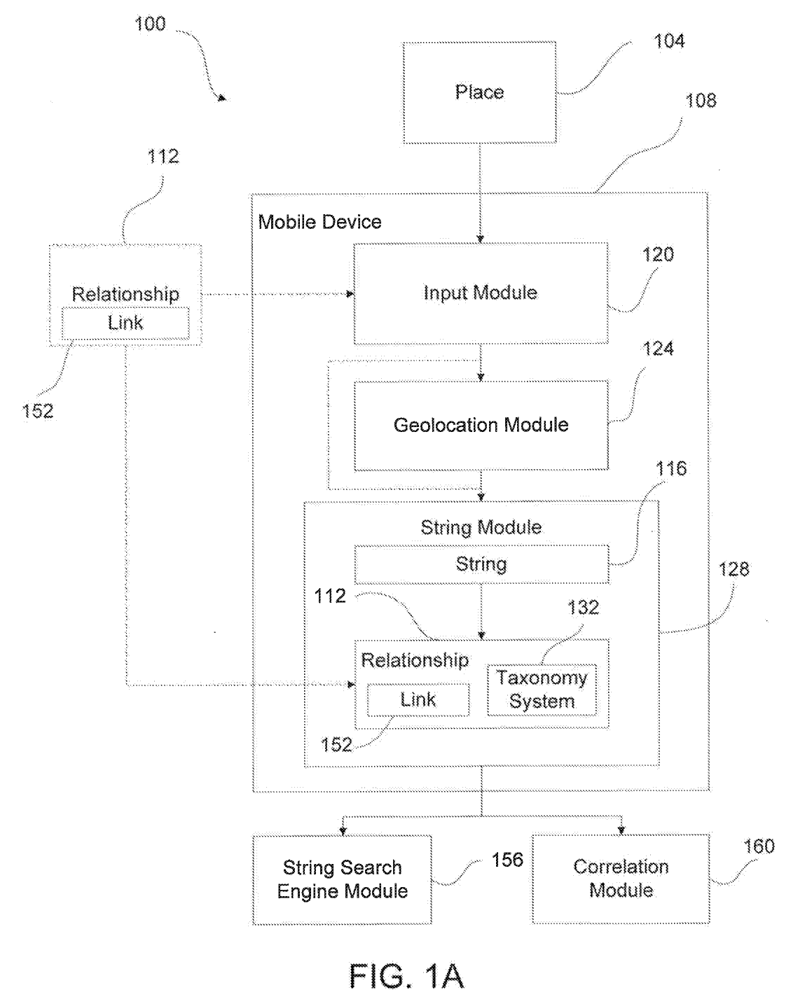

FIG. 1 illustrates an embodiment of a GSBS 100 configured to identify, communicate, select, and otherwise interact with an information system 102. Information system 102 may be used to communicate a wide variety of content, information, and/or data between components of information system 102, the content or information including, but not limited to, user preferences, user situational factors, including time, date, weather, and user location, or other information and content that can influence the character and performance of a string.

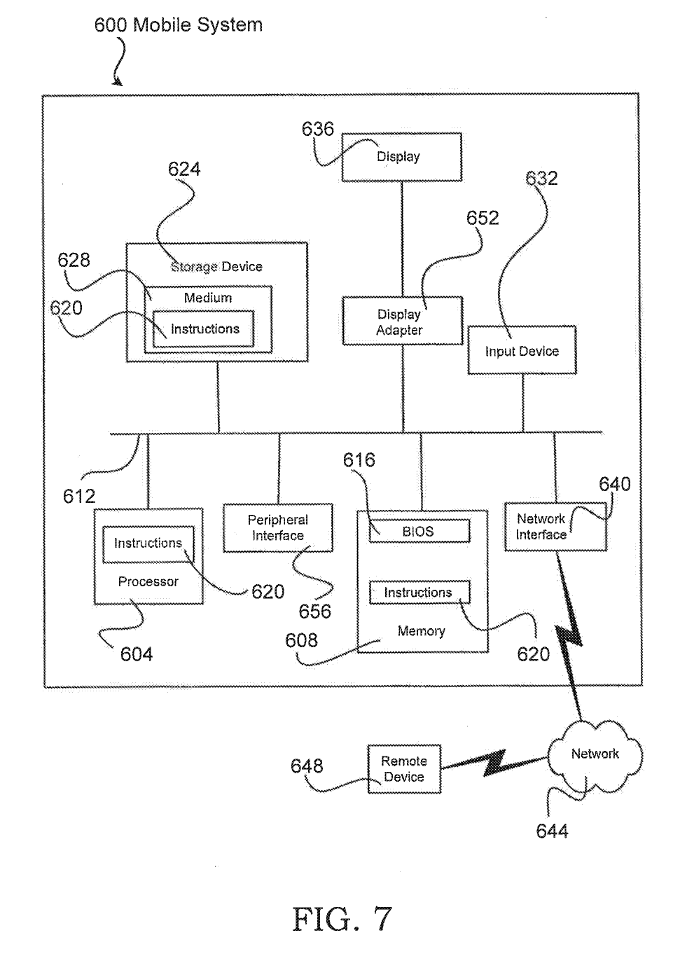

In an exemplary embodiment, information system 102 includes a network 106 and one or more mobile devices 108 that can include some or all of GSBS 100. In an embodiment, mobile device 108 can be a device, such as, but not limited to, a smartphone, global positioning system (GPS) device, or may be a pad or a tablet computing device, a smart book, a net book, a laptop, and other devices with geolocation functionality that may be moved from one location to another without significant inconvenience. GSBS 100 may be accessed on or interacted with through mobile device 108, by, for example, a user performing an overt action with respect to a user interface element (discussed further below with reference to FIG. 7) on the mobile device, such as touching an element or clicking on an element on the mobile device screen, so as to indicate that place 104 being selected is the location of the mobile device at the time the overt action is taken. Mobile device 108 may communicate with one or more components of information system 102, such as, but not limited to, other mobile devices 108, a content source 110, and one or more computing devices 114. Mobile device 108 may communicate to the aforementioned devices through network 106, mobile network 118, and/or local area network (LAN) 122, so as to access, record, store, or retrieve information, such as place, user, string, and/or or relationship information (discussed in detail below with reference to FIG. 1A), in content source 110. Content source 110 can be, for example, a machine readable storage medium or a database, whether publicly accessible, privately accessible, or accessible through some other arrangement such as subscription, that holds, for example, information, data, programs, algorithms, or computer code, which is thereby accessible by mobile device 108.

As those skilled in the art will appreciate, computing device 114 may take a variety of forms, including, but not limited to, a server computer, a web appliance, a laptop computer, a desktop computer, a computer workstation, a terminal computer, web-enabled televisions, media players, and other computing devices in communication with network 106.

Network 106 may be used in connection with information system 102 to enable communication between the various elements of the information system that can include elements of GSBS 100. For example, as indicated in FIG. 1, network 106 may be used by mobile device 108 to communicate with content source 110 for storing and retrieving information needed by GSBS 100. Network 106 may also allow for mobile device to access certain software, algorithms, or other programs included with computing device 114. Those skilled in the art will appreciate that mobile device 108 can access information system 102 using any of a number of possible technologies including a cellular network, WiFi, wired internet access, combinations thereof, as well as others not recited, and for any of a number of purposes including, but not limited to, those reasons recited above.

GSBS 100 may also use information system as discussed in U.S. Provisional Application No. 61/483,373, filed May 6, 2011, and titled “Geo-Location Based Playlist System and Method,” to Meyer, to communicate between modules include with the GSBS. U.S. Provisional Application No. 61/483,373 is incorporated by reference for its discussion of the same. In an embodiment, communication between the modules included with GSBS 100 (discussed in detail below with reference to FIG. 1A) may be initiated through a webpage or application accessible on mobile device 108. The website or application may be instantiated in a web-based environment existing on a web-page that is accessible through an information network, such as network 106. Mobile device 108 may also use the information network to facilitate communication between the mobile device and a content source, such as content source 110.

Turning now to FIG. 1A, GSBS 100 includes one or more software modules configured to allow for the designation of a place 104 by a user via a mobile device 108, the generation of strings based upon the locations designated by the user, and the assignment of relationships to the strings. As discussed further below, one or more of the modules included with GSBS 100 facilitates the input of a designation of place 104 that the user is at, wishes to be at, or has been at before. The location of place 104 may be any geolocatable position, thereby allowing an author to enhance the experience by designating a unique place that is associated with other places the author wishes to include in his or her experience. Two or more of places 104 can then be assembled and be given or attributed a relationship 112, so as to create a string 116. In this way, a user may review, revise, distribute to other connections (e.g., other persons part of the user's social network), allow to be viewed or searched, his or her strings 116 and provide an indication of the relationship associated with the string so as to enrich the experience for the others viewing, editing, or wishing to recreate the string. In an embodiment, string 116 may be considered a social media object, the social media object being communicable between others in the user's social network and/or creating a link for others to converge on a discussion or participation of the string.

In an exemplary embodiment, GSBS 100 includes an input module 120, a geolocation module 124, and a string module 128. Input module 120 allows for inputting data, e.g., place 104, from a user into GSBS 100. Input module 120 permits a user to designate any geolocatable place as a location. As noted, a user may designate the location on mobile device 108 by ways known in the art, such as, but not limited to, touching a spot on a touchscreen, voicing a command, or directing a trackball.

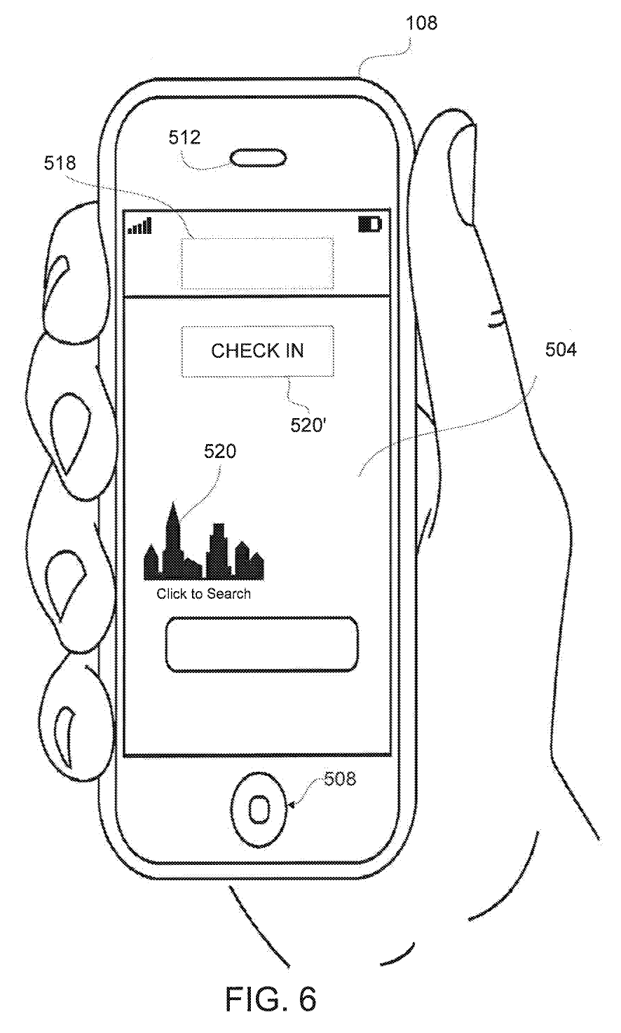

Input module 120 may also allow a user to include other related information to the geolocatable place. For example, a user may input a time of arrival at the place, an experience the user had at the place, the type of event occurring at the place, and the like. A person of ordinary skill in the art should understand that some of the aforementioned pieces of related information may be generated automatically when the user designates a geolocatable place. For example, if the user designates a geolocatable place on mobile device 108, e.g., by tapping a user interface element with a command such as “Record This,” the mobile device may concomitantly record the geolocation of the mobile device and a time-stamp associated with the designation. The data input by a user into input module 120 may be stored in a database (described further below with reference to FIG. 6) for later retrieval or processing.

Geolocation module 124 is configured to act upon the request of the user, via input module 120, so as to identify and record the location of place 104, which in some embodiments may be a pair of coordinates (i.e., latitudinal and longitudinal) representative of the location of the user, the location of mobile device 108, an address of a business, an event location, a website address, or other addressable or geolocatable places. It should be appreciated by those of ordinary skill in the art that location information can be obtained in a number of different ways. For example, location information can be retrieved via global positioning system (GPS) technology. In another example, a user carrying mobile device 108 may be identified by a component of a mobile network (e.g., a location server, a presence server, a router, etc.) that mobile device 108 is connected to. In another example, triangulation techniques using multiple cell towers can be used to determine mobile device 108 location information. In yet another example, satellite locating techniques can be utilized to determine location information associated with mobile device 108.

In an embodiment, mobile device 108 includes technology for determining its location or ascertaining information associated with its location. Mobile device 108 can then communicate that information to another entity, such as one or more networks 106, 118, or 122 (FIG. 1), or another entity can retrieve that data from the mobile device. When mobile device 108 communicates with another device, such as computing device 114 (FIG. 1), the mobile device is associated with identifying information such as addressing information, presence information, and the like. For example, mobile device 108 can become associated with an internet protocol (IP) address, a MAC address, a network port, or any number of other types of addressing or locating information. IP addresses, MAC addresses, and others can be analyzed to ascertain information about the location of mobile device 108. Alternatively, mobile device 108 can utilize an address associated with a computing device, such as computing device 500 (discussed below with reference to FIG. 6), an internet service provider, a local area network, and the like. Communications can be monitored to detect, record, and analyze addressing information, presence information, and other types of information relevant to location information of mobile device 108. In yet another embodiment, geolocation module 124 may be installed on a computing device and the data from input module 120 may be transferred over a network or via other means to the geolocation module 124.

String module 128 uses as inputs the two or more places 104 recorded by geolocation module 124 and can generate or be configured to accept a relationship 112, via input module 120, based on the two or more places so as to develop string 116. Places 104 are connected by relationship 112, which can be articulated by a user or inferred by or transferred to a string module 128, for example, through a global network information system such as an internet-based webpage or an app. Relationship 112 can include a theme, a narrative, or a trait that is common to places 104 of string 116 or otherwise unites the places so as to produce a cohesive user experience. Some factors that can be used to establish relationship 112 between places 104 of string 116 include, but are not limited to, geolocations of each place 104, the temporal proximity between places, correlations between places, cost of or spending at each place, the timeframe associated with the string (total time to visit/access all places in the string), and/or the narrative supplied with the string that provides a description of the string experience. For example, temporal proximity of places 104 may be a component used to create a quality or type of experience intended by the author of string 116. In another example, temporal proximity can be used to establish relationship 112 between places 104 in the event that one of the places is accessible to users only within a defined period of time. In one embodiment, string 116 entitled “An Afternoon in Asia” could include as place 104 an Asian exhibit at a local museum, followed by a formal tea service at a Japanese tea house. This embodiment of string 116 includes an Asian theme relationship 112 as described, optionally, by a narrative, which includes the string title, explaining the connection between the two places 104 and uniting the places through a theme. In this embodiment, places 104 may also share relationship 112 of temporal proximity that is defined by the hours of operation of the museum and the Japanese tea house and have a timeframe such that the user experience of engaging in the two events is further captured.

The connection between the author and a string 116 created by the author can be further enhanced using an author's profile, which in some embodiments, may also provide context and information to assist in forming relationship 112. For example, an author can provide a narrative or description characterizing the author's preferences, persona, profession, activities, age, marital status, home town, neighborhood, hobbies, etc. In another example, an author can use existing online information to provide or inform the profile. Existing online information can include a Facebook® profile, information as to friends, places, comments, and activities extracted from a Facebook account or other similar social media forum. In yet another example, information (including meta-data) from an author's mobile phone, smart phone, or computer can be extracted to contribute to a profile. For example, hobbies, locations of friends and family, and so forth can be extracted based on internet browsing history and phone number data. Once populated and periodically updated, the information in the profile can be used to establish relationship 112.

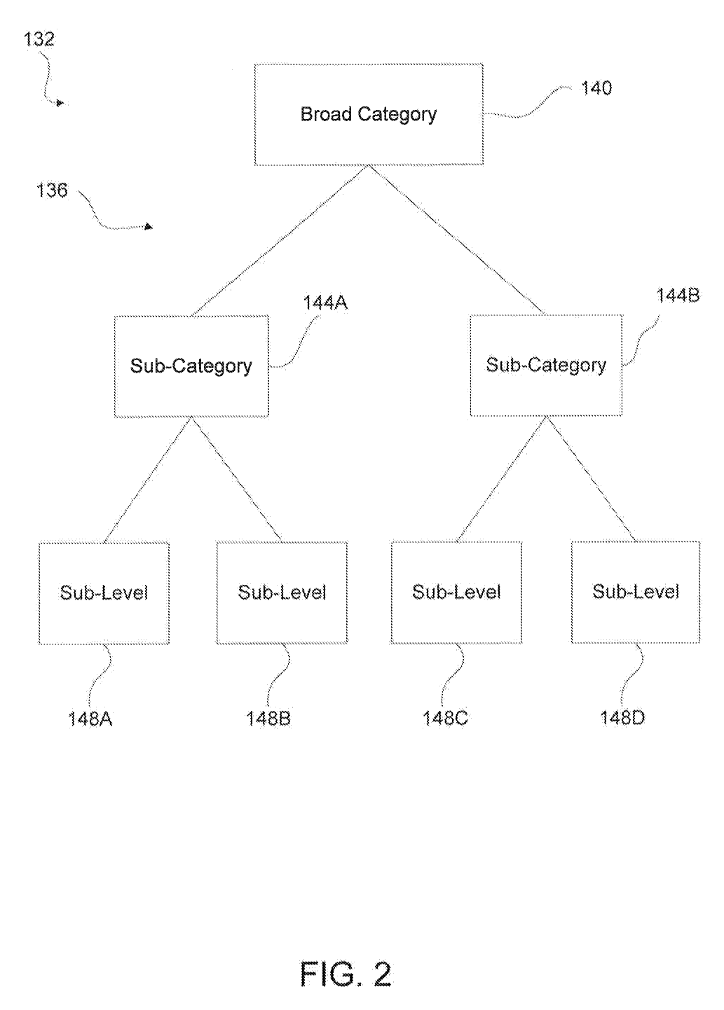

Relationships 112 can further be determined by categorizing traits of places and strings using a taxonomy system 132, shown in FIG. 2. In general, taxonomy refers to terms that may be associated with a place 104. In an embodiment, taxonomy system 132 can be structured to include a number of interrelated and associated category levels 136 that contain pre-defined place classifications. Category levels 136 are related such that a broad level category 140 includes one or more sub-categories 144, with, in certain embodiments, one or more sub-levels 148 disposed thereunder. This structure can be repeated to create a series of successively narrower sub-categories. For example, and as shown in FIG. 2, broad category level 140 could be “stores” with successively narrower sub-categories including “musical equipment stores” (sub-category 144A) with sub-levels including “piano stores” and “antique piano stores,” (sub-levels 148A-B, respectively) and “sports stores” (sub-category 144B) with sub-levels including “racquet sports” and ball sports, (sub-levels 148C-D, respectively). Classifications from broad category 140, any one or more sub-categories 144, or sub-levels 148 can then be assigned to places 104 or strings 116 to characterize the place, relationship 112 between places, or a string. Classifications can also be used to facilitate searching.

In addition to taxonomy, “folksonomy” can be used to develop an organization of places and strings using colloquial terminology and characterizations provided over time by users. In general, folksonomy does not initially include category levels 136, as the terms associated with the place are not predetermined. For example, a folkonomy can develop either through an affirmative solicitation by GSBS 100 for characterizations submitted by users or through an examination performed by the GSBS of user-provided narratives. In another example, GSBS 100 can search for and determine whether multiple users describe or characterize the same place 104 using recurring themes or terms. These recurring themes or terms can then be applied in the same way as a taxonomy 132, and used to describe or classify places 104, strings 116, authors, relationships 112, or the quality of experience.

String 116, as discussed above, includes at least two places having a unique location. In this context, the term “location” is intended to be defined broadly. That is, and in coordination with geolocation module 124, a location can include any geolocatable place. For example, a location can include an address of a physical place, whether a street address, an intersection name, a location identified by a landmark, or a GPS coordinate, also known as a geolocation position.

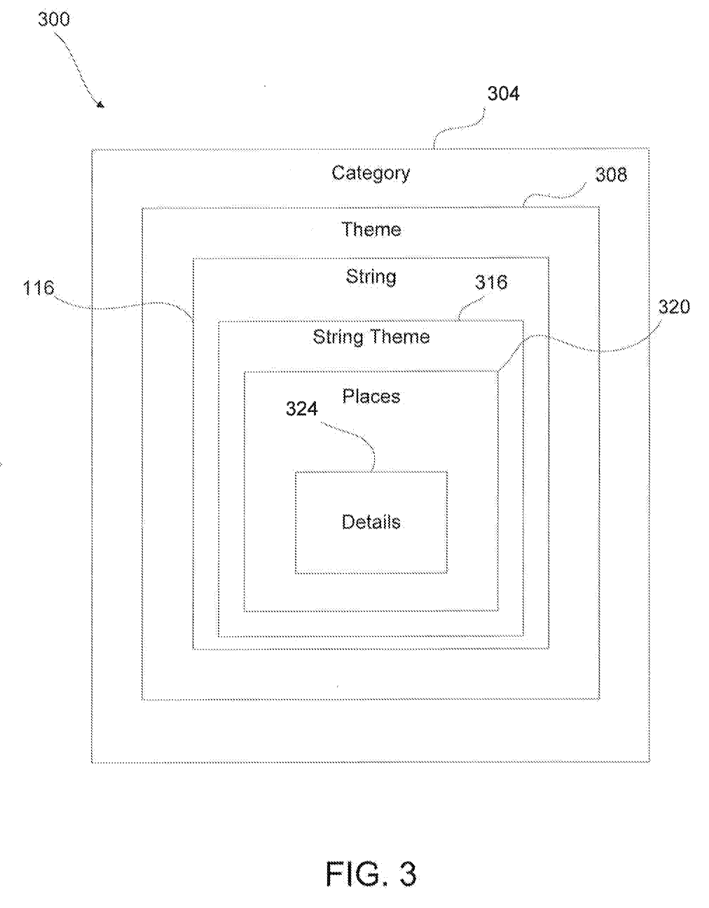

In some embodiments, places 104 and strings 116 can be hierarchically organized under themes and subthemes. FIG. 3 schematically depicts an example of such a hierarchical structure 300 for strings 116. String 116 presented to a user may be organized within one or more categories 304 within hierarchical structure 300. Each category 304 may, in some embodiments, have a unique theme 308 that is common to strings 116 within the category, but differs from the themes of the other categories. In other embodiments, the categories 304 in string 116 may have a similar theme or even the same theme. Similar to the diversity possible between the various categories 304, the strings 116 within a given category may also be distinct from each other while remaining consistent to the theme of the overarching category.

As shown in FIG. 3, each string 116 may include a unique string theme 316, wherein each string theme is consistent with the overarching category theme and the second theme of the hierarchical structure. As mentioned previously, strings 116 may include a plurality of places 320 (which may be places 104), e.g., visiting a garden, dining at a specified restaurant, and watching a show. As with strings 116 within category 304, places 320 may, in some examples, be diverse from each other, but nonetheless consistent with both the first theme of category 304 and the second theme of string 116. In some cases, it may be desirable to associate details 324 with one or more places 320, including, but not limited to, user comments, promotions and special offers, and the ability to invite others to a destination or string. As discussed more below, in some cases a user may provide details 324 and in other cases the details may be provided by the entity operating GSBS 100. In the former case, for example, a user may add an alternative destination to string 116, through suitable user interface functionality, e.g., input module 120, or a web-based database of places that are searchable and selectable by the user. In an embodiment, GSBS 100 is structured so that any additions to string 116 added by a user are consistent with the themes of the string 116 and category 304 in which the destination is added. In other embodiments, such limitation may not be desired. Interface functionality, included with, for example, mobile device 108, may also permit a user to rate the string and/or rate the author of the string, thereby providing additional information. Other details 324 may also be added to places 316, as those skilled in the art will appreciate.

Returning now to FIG. 1A, each relationship 112 includes one or more links 152. In general, links 152 are specific elements of relationship 116. For example, link 152 can be a temporal link between each place identified in the string. A temporal link can be important to certain types of strings 116 because the string may need to be completed within a certain time frame in order to properly characterize the user's experience at those places 104 or for other reasons. Additionally, for some strings 116, the sequence of events may require that certain places 104 be visited at certain times. For instance, if an exemplary string 116 include three places, such as, a restaurant, a park bench, and a comedy club, and the show at the comedy club has a certain start time, going to the restaurant and then the park bench would require a certain timing so as to afford a reviewer/re-creator of the string an opportunity to experience the relationship associated with the string. In another embodiment, link 152 may be physical proximity. In yet another embodiment, link 152 may be a theme or narrative designated by the user. In a further embodiment, link 152 may be a combination of one or more of the above referenced items.

GSBS 100 may also include a string search engine 156. String search engine 156 facilitates the searching of existing strings 116 located in a database associated with GSBS 100, such as a database included with content source 110 (FIG. 1). String search engine 156 may be configured to allow for searching of strings 116 using a variety of different criteria. For example, string search engine 156 may search existing strings 116 by the user who input the string. In another example, string search engine 156 may search existing strings 116 by place 104. In yet another example, string search engine 156 may search existing strings 116 by proximity to a desired location, for instance, if a searcher would like to view all of the strings located near a certain location or destination, e.g., Boston, Mass., Stowe, Vt., etc. In this example, string search engine 156 would return all strings 116 in the locale designated by the searcher. In yet a further example, string search engine 156 may allow a search by places 104 associated with a string 116. In this example, a place of interest would be input into string search engine 156 and the string search engine would return all of those strings 116 that included the place of interest.

GSBS 100 may also include a correlation module 160. Correlation module 160 assists in determining various relationships between one or more places 104 or one or more strings 116 designated by a user. In an embodiment of correlation module 160, the correlation module can determine, based upon strings 116, a frequency of occurrence of a sequence of places 104 across multiple strings. The frequency of occurrence can indicate a strong or preferred relationship between two or more places 104.

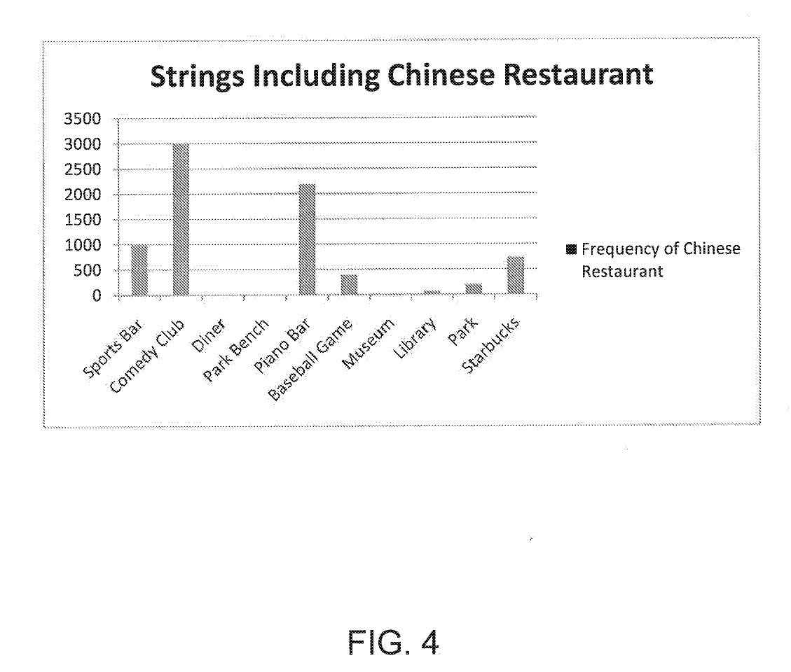

For example, and as shown in FIG. 4, a histogram displays the frequency of strings 116 that have in common at least one place 104, which, in this example, is a Chinese restaurant (the “Chinese restaurant strings”). The other places 104 included within the Chinese restaurant strings are, a sports bar, a comedy club, a diner, a park bench, a piano bar, a baseball game, a museum, a library, a park, and a Starbucks® coffee shop. As shown in the histogram in FIG. 4, the comedy club is the most frequently connected place to the Chinese restaurant. Correlation module 160 allows for this determination, which can subsequently allow for the suggestion of the comedy club to other persons using GSBS 100 who may be desiring an experience involving the Chinese restaurant and an additional place 104. Thus, a relationship 112 can be inferred via the use of correlation module 160, which based upon user behavior correlating two or more places 104.

For example, because a user can indicate his arrival at a first place 104 (Chinese restaurant) using mobile device 108, or such arrival can be automatically detected, GSBS 100 can make correlations using correlation module 160 to point the user to other places based on frequency and temporal proximity data sent by users. As another example, referring to the preceding embodiment, GSBS 100 can correlate the Asian exhibit at the museum with the Japanese tea house based on the frequency of user visits, and the temporal proximity between visits to places 104. This inferred relationship 112 can then be used for a number of purposes, including alerting the user of this previously unrecognized correlation or creating a string that includes the correlated places 104.

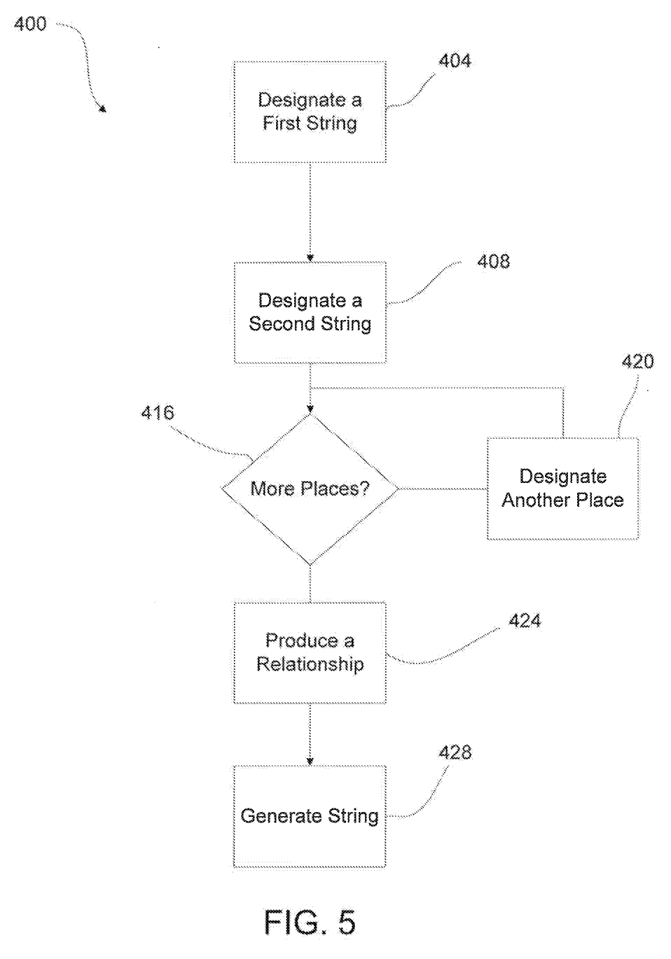

Turning now to FIG. 5, a method 400 of building a string with a mobile device is depicted. At step 404 a first place is designated using a mobile device. Such designation may occur when the mobile device is located at the first place and may be effected by the user taking an action with respect to a user interface element on the mobile device, as discussed more below. The first place can be any place having an address or geolocatable position. In an example, the first place has an associated with it a window, which is a time period in which the first place should be visited or accessed. The first place may also include entity related information. As discussed previously, entity related information can be information that is publically accessible via an information source (e.g., website) about the place. Examples of entity related information may be hours of operation, entity type, entity character, or entity services.

At step 408 a second place is designated using the mobile device. As with the first place, such second place may be designated by the user when the mobile device is located at the second place. In the embodiment shown in FIG. 5, the second place is a place that does not include any entity related information. The second place can include, for example, a park bench, a tree, or a quiet spot along a river. As with the first place, the second place can also include a window. In some implementations, both the first and second places are designated when the mobile device is located, respectively, at the first and second places. In other implementations, just one of the first and second places is designated when the mobile device is located at such one place.

Designation of the first place or the second place may be made using a user interface element presented on a touch screen or other input device available on mobile device 108. For example, upon arrival at the first place, a user may designate the first place by tapping a soft button displayed on the touch screen of the mobile device, at which point the mobile device can use a geolocation module to determine the location, e.g., coordinates, address, etc., of the place. In this way, first place and second place may be any geolocatable place to which a user may travel.

At step 412, a determination as to whether more places should be included prior to generation of a string, such as string 116. If further places are to be included, the process proceeds to step 416, where another place is designated. The additional places may or may not include entity related information as appropriate for the place designated by the user. If no further places are to be designated, the process proceeds to step 420.

At step 420, a relationship, such as relationship 112, is produced. Production of the relationship can encompass associations between the first place and the second place, such as, but not limited to, physical proximity of the first and second place, the characteristics of the first place and the second place, the overall time (also referred to as timeframe) for visiting or accessing the first place and the second place, and the association of the respective windows for visiting or accessing the first place and the second place, or correlations based upon the first place or second place. For example, a user that designates a first place, such as a restaurant having a window of between 5 pm and 7 pm, and second place, such as a scenic overview point for watching a sunset having a window of 7:30 pm and 8:30 pm, can have a relationship including, for example, a timeframe of between 5 pm and 8:30 pm, a distance between the first place and second place, and/or the sequence and timing (i.e., windows) of each place such that an experience of the user may be created and recreated by the user or others.

At step 424, a string, such as string 116, is generated. The string is generated based upon the first place, the second place, and the associated relationship produced in step 420. The string represents an experience of the string author that has a quality, character, and/or feel intended by the string author.

In an embodiment of process 400, the string generated in step 424 may be further processed. For example, the string may be stored in a database, the database suitable for storing tens of thousands, if not millions, of strings or more. This initial string may then be compared to other strings in the database. The comparison may allow for the initial string to be categorized among other strings such that the other strings may be suggested to the author of the initial string. Alternatively, and as discussed above, the comparison may involve determining a frequency of occurrence of the two places or types of relationships that occur.

It is to be noted that any one or more of the aspects and embodiments of process 400 and/or GSBS 100, as described herein, may be conveniently implemented using one or more machines (e.g., one or more mobile devices 108) programmed according to the teachings of the present specification, as will be apparent to those of ordinary skill in the computer art. Aspects and implementations of GSBS 100, discussed above, employing software and/or software modules may also include appropriate hardware for assisting in the implementation of the machine executable instructions of the software and/or software module.

FIG. 6 shows a one implementation of a mobile device 108 including a touch-sensitive display 504, an input device 508, a speaker 512, and a transceiver 518. Touch-sensitive display 504 is sometimes called a “touch screen” for convenience, and may also be known as or called a touch-sensitive display system. Touch screen 504 can be used to display information or to provide user-interface objects 520 (e.g., virtual (also called “soft”) control keys, such as buttons or keyboards), thereby providing an input interface and an output interface between mobile device 108 and a user. Information displayed by touch screen 504 can include graphics, maps, text, icons, video, and any combination thereof (collectively termed “graphics”). In an embodiment, and in use with GSBS 100, a user can select one or more user-interface objects 520, e.g., object 520′, using touch screen 504 to designate that mobile device 108 is at a present location.

Touch screen 504 has a touch-sensitive surface, which uses a sensor or set of sensors to accepts input from the user based on haptic and/or tactile contact. Touch screen 504 may use LCD (liquid crystal display) technology, or LPD (light emitting polymer display) technology, although other display technologies may be used in other embodiments. Touch screen 504 can detect contact (and any movement or breaking of the contact) on the touch screen and converts the detected contact into interaction with user-interface objects (e.g., one or more soft keys, icons, web pages or images) that are displayed on the touch screen. Touch screen 504 may detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with a touch screen 504. In an exemplary embodiment of the use of mobile device 108, a user presses a finger to touch screen 504 so as to initiate contact. In alternative embodiments, a user may make contact with touch screen 504 using any suitable object, such as, but not limited to, a stylus.

Input device 508 facilitates navigation among and interact with one or more user-interface objects 520 displayed in the touch screen 504. In an embodiment, input device 508 is a click wheel that can be rotated or moved such that it can be used to select one or more user-interface objects 520 displayed on touch screen 504. In an alternative embodiment, input device 508 can be a virtual click wheel, which may be either an opaque or semitransparent object that appears and disappears on the touch screen display in response to user interaction with mobile device 108.

Transceiver 518 receives and sends signals from mobile system 600. In an embodiment of mobile device 108, transceiver 518 sends and receives radio frequency signals through one or more communications networks, such as network 106 (FIG. 1), and/or other computing devices, such as computing device 114. Transceiver 518 may be combined with well-known circuitry for performing these functions, including, but not limited to, an antenna system, one or more amplifiers, a tuner, one or more oscillators, a digital signal processor, a CODEC chipset, a subscriber identity module (SIM) card, and a memory. As mentioned above, transceiver 518 may communicate with one or more networks, such as the Internet, also referred to as the World Wide Web (WWW), an intranet and/or a wireless network, such as a cellular telephone network, a wireless local area network (LAN), and/or a metropolitan area network (MAN), and other devices. Mobile device 108 may use any of a plurality of communications standards to communicate to networks or other devices with transceiver 518. Communications standards, protocols and technologies for communicating include, but are not limited to, Global System for Mobile Communications (GSM), Enhanced Data GSM Environment (EDGE), high-speed downlink packet access (HSDPA), wideband code division multiple access (W-CDMA), code division multiple access (CDMA), time division multiple access (TDMA), Bluetooth, Wireless Fidelity (Wi-Fi) (e.g., IEEE 802.11a, IEEE 802.11b, IEEE 802.11g and/or IEEE 802.11n), voice over Internet Protocol (VoIP), Wi-MAX, a protocol for email (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), and/or Instant Messaging and Presence Service (IMPS)), and/or Short Message Service (SMS)), or any other suitable communication protocol.

Transceiver 518 may also be configured to assist mobile device 108 in determining its current location. In an exemplary embodiment, mobile device 108 includes a geolocation module, such as geolocation 124 (FIG. 1A). In this embodiment, the geolocation module provides signals to transceiver 518 that are suitable for determining the location of mobile device 108, as discussed in detail above.

Mobile device 108 may also include other applications or programs such as, but not limited to, word processing applications, JAVA-enabled applications, encryption, digital rights management, voice recognition, voice replication, and a browser module. The browser module may be used to browse the Internet, including searching, linking to, receiving, and displaying web pages or portions thereof, as well as attachments and other files linked to web pages.

It should be appreciated that the mobile device 108 is only one example of the mobile device that may be used with the present system and method, and that the mobile device may have more or fewer components than mentioned, may combine two or more components, or a may have a different configuration or arrangement of the components. In the present system and method, mobile device 108 be implemented with any computing device that includes geolocation functionality and is not so large that it is very inconvenient to move it from one location to another. Thus, mobile device 108 is not restricted to a smartphone or other hand-held device, and may include pad or tablet computing devices, smart books, net books, laptops, and even larger computing devices with geolocation functionality that may be moved from one location to another without significant inconvenience.

The various components shown in FIG. 6 may be implemented in hardware, software or a combination of both hardware and software, including one or more signal processing and/or application specific integrated circuits. Software, as discussed above, may be a computer program product that employs a machine-readable storage medium. A machine-readable storage medium may be any medium that is capable of storing and/or encoding a sequence of instructions for execution by a machine (e.g., mobile device 108) or a portion of the machine and that causes the machine to perform any one of the methodologies and/or embodiments described herein. Examples of a machine-readable storage medium include, but are not limited to, a magnetic disk, an optical disk, a magneto-optical disk, a read-only memory “ROM” device, a random access memory “RAM” device, a magnetic card, an optical card, a solid-state memory device (e.g., a flash memory), an EPROM, an EEPROM, and any combinations thereof. A machine-readable medium, as used herein, is intended to include a single medium as well as a collection of physically separate media, such as, for example, a collection of compact disks or one or more hard disk drives in combination with a computer memory. As used herein, a machine-readable storage medium does not include a signal.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine and any related information (e.g., data structures and data) that causes the machine to perform any one of the methodologies and/or embodiments described herein.

FIG. 7 shows a diagrammatic representation of one embodiment of mobile device 108 in the exemplary form of a mobile system 600, within which a set of instructions for causing a processor 604 to perform any one or more of the aspects and/or methodologies, such as process 400, of the present disclosure. It is also contemplated that multiple mobile devices or combinations of computing devices and mobile devices may be utilized to implement a specially configured set of instructions for causing GSBS 100 to perform any one or more of the aspects and/or methodologies of the present disclosure.

Mobile system 600 can also include a memory 608 that communicate with each other, and with other components, via a bus 612. Bus 612 may include any of several types of bus structures including, but not limited to, a memory bus, a memory controller, a peripheral bus, a local bus, and any combinations thereof, using any of a variety of bus architectures.

Memory 608 may include various components (e.g., machine readable media) including, but not limited to, a random access memory component (e.g., a static RAM “SRAM”, a dynamic RAM “DRAM”, etc.), a read only component, and any combinations thereof. In one example, a basic input/output system 616 (BIOS), including basic routines that help to transfer information between elements within mobile system 600, such as during start-up, may be stored in memory 608. Memory 608 may also include (e.g., stored on one or more machine-readable media) instructions (e.g., software) 620 embodying any one or more of the aspects and/or methodologies of the present disclosure. In another example, memory 608 may further include any number of program modules including, but not limited to, an operating system, one or more application programs, other program modules, program data, and any combinations thereof.

Mobile system 600 may also include a storage device 624, such as, but not limited to, the machine readable storage medium described above. Storage device 624 may be connected to bus 612 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 624 (or one or more components thereof) may be removably interfaced with mobile device system 600 (e.g., via an external port connector (not shown)). Particularly, storage device 624 and an associated machine-readable medium 628 may provide nonvolatile and/or volatile storage of machine-readable instructions, data structures, program modules, and/or other data for mobile system 600. In one example, software 620 may reside, completely or partially, within machine-readable medium 628. In another example, software 620 may reside, completely or partially, within processor 604.

Mobile system 600 may also include an input device 632, such as touch screen 504, input device 508, or other internal or external input devices. Additional examples of an input device 632 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), and any combinations thereof. Input device 632 may be interfaced to bus 612 via any of a variety of interfaces (not shown) including, but not limited to, a serial interface, a parallel interface, a game port, a USB interface, a FIREWIRE interface, a direct interface to bus 612, and any combinations thereof. Input device 632 may include a touch screen interface that may be a part of or separate from display 636, discussed further below. Input device 632 may be utilized as a user selection device for selecting one or more graphical representations in a graphical interface as described above.

A user may also input commands and/or other information to mobile system 600 via storage device 624 (e.g., a removable disk drive, a flash drive, etc.) and/or network interface device 640. A network interface device, such as network interface device 640 may be utilized for connecting mobile system 600 to one or more of a variety of networks, such as network 644 or networks 106 of FIG. 1, and one or more remote devices 648 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network, a telephone network, a data network associated with a telephone/voice provider, a direct connection between two computing devices, and any combinations thereof. A network, such as network 644, may employ a wired and/or a wireless mode of communication. In general, any network topology may be used. Information (e.g., data, software 620, etc.) may be communicated to and/or from mobile system 600 via network interface device 640.

Mobile system 600 may further include a video display adapter 652 for communicating a displayable image to a display device, such as display device 636. Examples of a display device include, but are not limited to, a liquid crystal display (LCD), a cathode ray tube (CRT), a plasma display, a light emitting diode (LED) display, and any combinations thereof. Display adapter 652 and display device 636 may be utilized in combination with processor 604 to provide a graphical representation of a utility resource, a location of a land parcel, and/or a location of an easement to a user. In addition to a display device, mobile system 600 may include one or more other peripheral output devices including, but not limited to, an audio speaker, a printer, and any combinations thereof. Such peripheral output devices may be connected to bus 612 via a peripheral interface 656. Examples of a peripheral interface include, but are not limited to, a serial port, a USB connection, a FIREWIRE connection, a parallel connection, and any combinations thereof.

Exemplary embodiments have been disclosed above and illustrated in the accompanying a be understood by those skilled in the art that various changes, omissions and additions may be made to that which is specifically disclosed herein without departing from the spirit and scope of the present invention.

What is claimed is:

1. A mobile geolocation relationship building system, comprising:
a mobile device coupled to a computer readable storage medium;
a geolocation module configured to record in said computer readable storage medium an address for each of a plurality of places, wherein each of said plurality of places has a window associated therewith, and wherein at least one of said plurality of places does not include entity-related information; and
a string module configured to develop a string including said plurality of places, wherein said plurality of places have a relationship that includes a first sequence of said windows associated with said plurality of places.

2. A system according to claim 1, wherein said of said plurality of places is classified via a taxonomy system.

3. A system according to claim 1, wherein said relationship includes a link and wherein said link is temporal proximity.

4. A system according to claim 1, wherein said relationship includes a link and wherein said link is an attribute defined by the user.

5. A system according to claim 3, wherein said link further includes physical proximity.

6. A system according to claim 1, wherein said relationship further includes a correlation between at least two of said plurality of places.

7. A system according to claim 1, wherein said system further includes a string search engine.

8. A geolocation relationship building system comprising:
a mobile device;
a machine readable storage medium including:
an input module responsive to a designation of a place; and
a string module configured generate a string including a plurality of said places, wherein at least one of said plurality of places does not include any entity related information, and wherein each of the plurality of places is assigned to a taxonomy category.

9. A system according to claim 8, wherein said string module further produces a relationship based upon at least two of said plurality of places.

10. A system according to claim 9, wherein said relationship includes the temporal proximity of said at least two of said plurality of places.

11. A system according to claim 9, wherein said relationship includes an attribute defined by the user.

12. A system according to claim 11, wherein said relationship further includes physical proximity.

13. A system according to claim 9, wherein said input module further receives a window associated with each place.

14. A system according to claim 13, wherein said relationship further considers said window associated with each of said place in said string.

15. A method of building relationships between at least two places designed by a user, the method comprising:
designating a first place with a mobile device using a user interface element on the mobile device, said designating occurring when the mobile device is located at the first place;
designating a second place with the mobile device using the user interface element on the mobile device, wherein the second place does not include any entity related information and said designating occurs when the mobile device is located at the second place;
producing a relationship between the first place and the second place based on a timeframe; and
generating a string including the first place, the second place, and the relationship.

16. A method according to claim 15, wherein the first place includes a first window and the second place includes a second window, and wherein the relations is further based on the first and second windows.

17. A method according to claim 15, the method further including assigning a taxonomy classification to the string.

18. A method according to claim 17, the method further including searching for a related string using the taxonomy classification.

19. A method of generating a string comprising:
receiving, from a mobile device having a user interface element, first place information, wherein the first place information represents a location of the mobile device, and wherein receipt of the first place information is initiated through the user interface element;
receiving, from the mobile device, second place information, wherein the second place information represents a location of the mobile device, wherein the second place does not include entity related information, and wherein receipt of the second place information is initiated through the user interface element;
producing a relationship associated with the first place and the second place based on the first place information, the second place information, and a timeframe; and
generating a string including the first place, the second place, and the associated relationship.

20. A method according to claim 19, wherein the first place information includes a first timestamp and the second place information includes a second timestamp, and wherein the relationship is further based on the first and second timestamps.

21. A method according to claim 19, the method further including assigning a taxonomy classification to the string.

22. A method according to claim 21, the method further including searching for a related string using the taxonomy classification.

23. A geolocation relationship building system for generating a string including a plurality of places, wherein at least one of the plurality of places does not include entity-related information, the system comprising:
a non-transitory computer-readable storage medium having executable computer program instructions for facilitating electronic analysis of the plurality of places, the computer program instructions including:
a geolocation module configured to record in said non-transitory computer readable storage medium an address for each of the plurality of places; and
a string module configured to develop a string having a relationship based upon the plurality of places, wherein said relationship includes a timeframe and a sequence of windows associated with the plurality of places.
